(19) United States
(12) Patent Application Publication
(10) Pub. No.: US 2008/0112630 A1
(43) Pub. Date: May 15, 2008

(54) DIGITAL VIDEO STABILIZATION BASED ON ROBUST DOMINANT MOTION ESTIMATION

(76) Inventors: Oscar Nestares, San Jose, CA (US); Horst Haussecker, Palo Alto, CA (US)

Correspondence Address: KACVINSKY LLC;C/O INTELLEVATE, P.O. BOX 52050, MINNEAPOLIS, MN, 55402, US

(21) Appl. No.: 11/558,131

(22) Filed: Nov. 9, 2006

(51) Int. Cl. G06K 9/36

(52) U.S. Cl. 382/236

(57) ABSTRACT

Various embodiments for performing digital video stabilization based on robust dominant motion estimation are described. In one embodiment, an apparatus may receive an input image sequence and estimate dominant motion between neighboring images in the image sequence. The apparatus may use a robust estimator to automatically detect and discount outliers corresponding to independently moving objects. Other embodiments are described and claimed.

### BACKGROUND

Many types of mobile devices such as video cameras, still cameras in movie mode, and cameras in cellular telephones and personal digital assistants (PDAs) allow the capture of image sequences which is causing significant growth in the amount of digital media acquired by users. In most cases, however, video is captured under non-ideal conditions and with non-ideal acquisition equipment. For example, in situations such as filming from a moving vehicle or during sporting activities, most videos show a high degree of unwanted motion or jitter. Even videos acquired in normal conditions show a certain amount of unwanted shaking. Most inexpensive and ubiquitous video devices do not provide features for stabilizing video sequences to compensate for such jitter.

Although some of the most expensive devices provide mechanical image stabilization, digital techniques are usually employed that typically involve calculating image motion based on pre-selected image regions within the image which are assumed to contain primarily background information. If an object of interest happens to be in this area, it violates the basic assumption, and the background motion estimation will be incorrect.

Other digital stabilization techniques involve estimating the motion across the entire image by integrating the image along the horizontal and vertical coordinates, respectively, and then calculating the motion by simple correlation of the two one-dimensional signals in consecutive frames. Such techniques are fast and can be implemented in hardware embedded within imaging devices, but tend to be inaccurate and may lead to biased motion estimates by calculating an average motion across all objects in the image.

Accordingly, improved digital video stabilization techniques are needed which can be performed while an image sequence is being acquired or after acquisition by post-processing captured image sequences to enhance the viewing experience of digital media.

### BRIEF DESCRIPTION OF THE DRAWINGS

FIG. 1 illustrates a media processing system in accordance with one or more embodiments.

FIG. 2 illustrates an inter-frame dominant motion estimation module in accordance with one or more embodiments.

FIG. 3 illustrates estimated and smoothed trajectories for a typical image sequence in accordance with one or more embodiments.

FIG. 4 illustrates stabilization results for two frames in accordance with one or more embodiments.

FIG. 5 illustrates a logic flow in accordance with one or more embodiments.

FIG. 6 illustrates an article of manufacture in accordance with one or more embodiments.

### DETAILED DESCRIPTION

Various embodiments are directed to performing digital video stabilization to remove unwanted motion or jitter from an image sequence. The digital video stabilization may be performed while an image sequence is being acquired. For example, digital video stabilization may be performed within an image acquisition device such as a video camera or mobile device with embedded imaging during image acquisition to automatically correct and remove unwanted jitter caused by camera shaking while still allowing camera panning.

Digital video stabilization also may be performed after image acquisition to process and view video streams. For example, digital video stabilization may be performed by a web-based media server, mobile computing platform, desktop platform, entertainment personal computer (PC), set-top box (STB), digital television (TV), video streaming enhancement chipset, media player, media editing application, or other suitable visualization device to enhance the viewing experience of digital media.

In various embodiments, digital video stabilization may be performed by receiving an input image sequence, estimating dominant motion between neighboring image frames in the input image sequence, determining an estimated trajectory based on the dominant motion between the neighboring image frames, determining a smoothed trajectory, calculating estimated jitter based on the deviation between the estimated trajectory and the smoothed trajectory, and then compensating for the estimated jitter to generate stabilized image sequence. The digital video stabilization may be implemented by purely digital techniques performed using the information in the video sequence without requiring any external sensor information.

The digital video stabilization may involve a statistical technique that automatically selects the correct motion for which to compensate by means of robust statistics. The technique automatically selects collections of pixels in the image that contain the dominant motion without having to pre-select regions of interest. By providing a formal definition of the dominant motion and estimation procedure based on the use of robust statistics, the resulting digital image stabilization technique does not need an ad-hoc definition of the dominant motion or the selection of regions from which the motion is estimated, but instead provides an estimate of the dominant motion based on rejecting the regions having a motion that is very different (in a statistical sense) from the dominant one. Consequently, excellent results may be obtained in sequences having multiple moving objects, independently of the relative location of the objects in the scene.

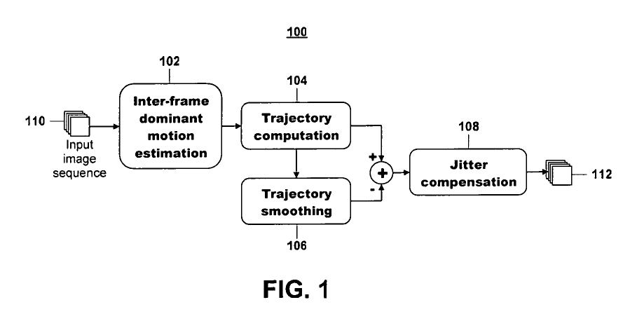

FIG. 1 illustrates a media processing system 100 in accordance with one or more embodiments. In general, the media processing system 100 may comprise various physical and/or logical components for communicating information which may be implemented as hardware, software, or any combination thereof, as desired for a given set of design parameters or performance constraints. Although FIG. 1 may show a limited number of components by way of example, it can be appreciated that a greater or a fewer number of components may be employed for a given implementation.

In various implementations, the media processing system 100 may be arranged to perform one or more networking, multimedia, and/or communications applications for a PC, consumer electronics (CE), and/or mobile platform. In some embodiments, the media processing system 100 may be implemented for a PC, CE, and/or mobile platform as a system within and/or connected to a device such as personal PC, STB, digital TV device, Internet Protocol TV (IPTV) device, digital camera, media player, and/or cellular telephone. Other examples of such devices may include, without limitation, a workstation, terminal, server, media appliance, audio/video (A/V) receiver, digital music player, entertainment system, digital TV (DTV) device, high-definition TV (HDTV) device, direct broadcast satellite TV (DBS) device, video on-demand (VOD) device, Web TV device, digital video recorder (DVR) device, digital versatile disc (DVD) device, high-definition DVD (HD-DVD) device, Blu-ray disc (BD) device, video home system (VHS) device, digital VHS device, a gaming console, display device, notebook PC, a laptop computer, portable computer, handheld computer, personal digital assistant (PDA), voice over IP (VoIP) device, combination cellular telephone/PDA, smart phone, pager, messaging device, wireless access point (AP), wireless client device, wireless station (STA), base station (BS), subscriber station (SS), mobile subscriber center (MSC), mobile unit, and so forth.

In mobile applications, for example, the media processing system 100 may be implemented within and/or connected to a device comprising one more interfaces and/or components for wireless communication such as one or more transmitters, receivers, transceivers, chipsets, amplifiers, filters, control logic, network interface cards (NICs), antennas, and so forth. Examples of an antenna may include, without limitation, an internal antenna, an omni-directional antenna, a monopole antenna, a dipole antenna, an end fed antenna, a circularly polarized antenna, a micro-strip antenna, a diversity antenna, a dual antenna, an antenna array, and so forth.

In various embodiments, the media processing system 100 may form part of a wired communications system, a wireless communications system, or a combination of both. For example, the media processing system 100 may be arranged to communicate information over one or more types of wired communication links. Examples of a wired communication link, may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The media processing system 100 also may be arranged to communicate information over one or more types of wireless communication links. Examples of a wireless communication link may include, without limitation, a radio channel, satellite channel, television channel, broadcast channel infrared channel, radio-frequency (RF) channel, Wireless Fidelity (WiFi) channel, a portion of the RF spectrum, and/or one or more licensed or license-free frequency bands. Although certain embodiments may be illustrated using a particular communications media by way of example, it may be appreciated that the principles and techniques discussed herein may be implemented using various communication media and accompanying technology.

In various embodiments, the media processing system 100 may be arranged to operate within a network, such as a Wide Area Network (WAN), Local Area Network (LAN), Metropolitan Area Network (MAN), wireless WAN (WWAN), wireless LAN (WLAN), wireless MAN (WMAN), wireless personal area network (WPAN), Worldwide Interoperability for Microwave Access (WiMAX) network, broadband wireless access (BWA) network, the Internet, the World Wide Web, telephone network, radio network, television network, cable network, satellite network such as a direct broadcast satellite (DBS) network, Code Division Multiple Access (CDMA) network, third generation (3G) network such as Wide-band CDMA (WCDMA), fourth generation (4G) network, Time Division Multiple Access (TDMA) network, Extended-TDMA (E-TDMA) cellular radiotelephone network, Global System for Mobile Communications (GSM) network, GSM with General Packet Radio Service (GPRS) systems (GSM/GPRS) network, Synchronous Division Multiple Access (SDMA) network, Time Division Synchronous CDMA (TD-SCDMA) network, Orthogonal Frequency Division Multiplexing (OFDM) network, Orthogonal Frequency Division Multiple Access (OFDMA) network, North American Digital Cellular (NADC) cellular radiotelephone network, Narrowband Advanced Mobile Phone Service (NAMPS) network, Universal Mobile Telephone System (UMTS) network, and/or any other wired or wireless communications network configured to carry data in accordance with the described embodiments.

The media processing system 100 may be arranged to communicate one or more types of information, such as media information and control information. Media information generally may refer to any data representing content meant for a user, such as image information, video information, audio information, A/V information, graphical information, voice information, textual information, numerical information, alphanumeric symbols, character symbols, and so forth. Control information generally may refer to any data representing commands, instructions or control words meant for an automated system. For example, control information may be used to route media information through a system, or instruct a node to process the media information in a certain manner. The media and control information may be communicated from and to a number of different devices or networks.

In various implementations, the media information and control information may be segmented into a series of packets. Each packet may comprise, for example, a discrete data set having a fixed or varying size represented in terms of bits or bytes. It can be appreciated that the described embodiments are applicable to any type of communication content or format, such as packets, frames, fragments, cells, windows, units, and so forth.

The media processing system 100 may communicate information in accordance with one or more protocols. A protocol may comprise a set of predefined rules or instructions for managing communication among nodes. In various embodiments, for example, the media processing system 100 may employ one or more protocols such as medium access control (MAC) protocol, Physical Layer Convergence Protocol (PLCP), Simple Network Management Protocol (SNMP), Asynchronous Transfer Mode (ATM) protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), and so forth.

The media processing system 100 may communicate information in accordance with one or more standards as promulgated by a standards organization, such as the International Telecommunications Union (ITU), the International Organization for Standardization (ISO), the International Electrotechnical Commission (IEC), the Institute of Electrical and Electronics Engineers (IEEE), the Internet Engineering Task Force (IETF), and so forth. In various embodiments, for example, the media processing system 100 may communicate information according to media processing standards such as, for example, the ITU/IEC H.263 standard (Video Coding for Low Bitrate Communication, ITU-T Recommendation H.263v3, published November 2000), the ITU/IEC H.264 standard (Video Coding for Very Low Bit Rate Communication, ITU-T Recommendation H.264, published May 2003), Motion Picture Experts Group (MPEG) standards (e.g., MPEG-1, MPEG-2, MPEG-4), Digital Video Broadcasting (DVB) terrestrial (DVB-T) standards, DVB satellite (DVB-S or -S2) standards, DVB cable (DVB-C) standards, DVB terrestrial for handhelds (DVB-H), National Television System Committee (NTSC) and Phase Alteration by Line (PAL) standards, Advanced Television Systems Committee (ATSC) standards, Society of Motion Picture and Television Engineers (SMPTE) standards such as the SMPTE 421M or VC-1 standard based on Windows Media Video (WMV) version 9, Digital Transmission Content Protection over Internet Protocol (DTCP-IP) standards, High performance radio Local Area Network (HiperLAN) standards, and so forth.

In some implementations, the media processing system 100 may be arranged to receive media content from a media source. The media source generally may comprise various devices and/or systems capable of delivering static or dynamic media content to the media processing system 100. In one embodiment, for example, the media source may comprise or form part of an image acquisition device such as a video camera or mobile device with imaging capabilities. The media source also may comprise a multimedia server arranged to provide broadcast or streaming media content. In other embodiments, the media source may comprise or form part of a media distribution system (DS) or broadcast system such as an over-the-air (OTA) broadcast system, DVB system, radio broadcast system, satellite broadcast system, and so forth. The media source may be implemented within a VOD system or interactive television system that allows users to select, receive, and view video content over a network. The media source also may comprise or form part of an IPTV system that delivers digital television content over an IP connection, such as a broadband connection. The embodiments are not limited in this context.

The media processing system 100 may be coupled to the media source through various types of communication channels capable of carrying information signals such as wired communication links, wireless communication links, or a combination of both, as desired for a given implementation. The media processing system 100 also may be arranged to receive media content from the media source through various types of components or interfaces. For example, the media processing system 100 may be arranged to receive media content through one or more tuners and/or interfaces such as an OpenCable (OC) tuner, NTSC/PAL tuner, tuner/demodulator, point-of-deployment (POD)/DVB common interface (DVB-CI), A/V decoder interface, Ethernet interface, PCI interface, and so forth.

The media content delivered to the media processing system 100 may comprise various types of information such as image information, audio information, video information, A/V information, and/or other data. In some implementations, the media source may be arranged to deliver media content in various formats for use by a device such as a STB, IPTV device, VOD device, media player, and so forth.

The media content may be delivered as compressed media content to allow the media processing system 100 to efficiently store and/or transfer data. In various implementations, the media content may be compressed by employing techniques such as spatial compression using discrete cosine transform (DCT), temporal compression, motion compensation, and quantization. Video compression of the media content may be performed, for example, in accordance with standards such as H.264, MPEG-2, MPEG-4, VC-1, and so forth. In some cases, the media content may be delivered as scrambled and/or encrypted media content to prevent unauthorized reception, copying, and/or viewing.

In various embodiments, the media processing system 100 may be arranged to perform digital video stabilization to remove unwanted motion or jitter from an image sequence. The digital video stabilization may be performed while an image sequence is being acquired. For example, the media processing system 100 may be implemented within an image acquisition device such as a video camera or mobile device with embedded imaging and may perform digital video stabilization during image acquisition to remove unwanted jitter caused by camera shaking while still allowing camera panning.

The digital video stabilization also may be performed after image acquisition to process and view video streams. For example, the media processing system 100 may be implemented by a web-based media server, mobile computing platform, desktop platform, entertainment PC, Digital TV, video streaming enhancement chipset, media player, media editing application, or other suitable visualization device to enhance the viewing experience of digital media. In some implementations, a user can selectively switch digital video stabilization features on and off to allow a stabilized viewing experience without modifying the original media content. The user also may modify an original video sequence or may save a stabilized version of the video sequence without modifying the original sequence. The digital video stabilization also can be used for more effective compression due to enhanced motion vector estimation once the sequence is stabilized (e.g., using MPEG compression).

In various embodiments, the media processing system 100 may be arranged to perform a statistical technique that automatically selects the correct motion for which to compensate by means of robust statistics. The technique automatically selects collections of pixels in the image that contain the dominant motion without having to pre-select regions of interest. By providing a formal definition of the dominant motion and estimation procedure based on the use of robust statistics, the resulting digital image stabilization technique does not need an ad-hoc definition of the dominant motion or the selection of regions from which the motion is estimated, but instead provides an estimate of the dominant motion based on rejecting the regions having a motion that is very different (in a statistical sense) from the dominant one. Consequently, excellent results may be obtained in sequences having multiple moving objects, independently of the relative location of the objects in the scene.

The media processing system 100 may be arranged to perform digital video stabilization by receiving an input image sequence, estimating dominant motion between neighboring image frames in the input image sequence, determining an estimated trajectory based on the dominant motion between the neighboring image frames, determining a smoothed trajectory, calculating estimated jitter based on the deviation between the estimated trajectory and the smoothed trajectory, and then compensating for the estimated jitter to generate stabilized image sequence.

As illustrated in FIG. 1, the media processing system 100 may comprise a plurality of functional units or modules. The modules may be implemented by one or more chips or integrated circuits (ICs) and may comprise, for example, hardware and/or software such as logic (e.g., instructions, data, and/or code) to be executed by a logic device. Examples of a logic device include, without limitation, a central processing unit (CPU), microcontroller, microprocessor, general purpose processor, dedicated processor, chip multiprocessor (CMP), media processor, digital signal processor (DSP), network processor, co-processor, input/output (I/O) processor, application specific integrated circuit (ASIC), field programmable gate array (FPGA), programmable logic device (PLD), and so forth.

Executable logic may be stored internally or externally to a logic device on one or more types of computer-readable storage media such as volatile or non-volatile memory, removable or non-removable memory, erasable or non-erasable memory, writeable or re-writeable memory, and so forth. The modules may be physically or logically coupled and/or connected by communications media comprising wired communication media, wireless communication media, or a combination of both, as desired for a given implementation. The embodiments are not limited in this context.

In various embodiments, the media processing system 100 may comprise a dominant inter-frame motion estimation module 102, a trajectory computation module 104, a trajectory smoothing module 106, and a jitter compensation module 108.

The inter-frame dominant motion estimation module 102 may be arranged to receive an input image sequence 110 comprising a series of digital video images. Each digital image or frame in the image sequence 110 may comprise horizontal (x) and vertical (y) image data or signals representing regions, objects, slices, macroblocks, blocks, pixels, and so forth. The values assigned to pixels may comprise real numbers and/or integer numbers.

The inter-frame dominant motion estimation module 102 may be arranged to estimate the dominant motion between neighboring images in the image sequence 110. The dominant motion may be a global displacement which corresponds to the assumption that the camera motion is a translation contained in the imaging plane. The dominant motion also can be a global displacement plus a rotation between the two images which corresponds to the assumption that the camera motion is a translation contained in the imaging plane plus a rotation around an axis orthogonal to the image plane. In such cases, the two neighboring images may be approximately displaced and potentially rotated versions of each other.

The inter-frame dominant motion estimation module 102 may estimate motion model parameters that best align the two images based on their gray levels, in the sense that the estimated alignment will correspond to the one that minimizes the difference of one of the images with the spatially transformed version of the second image. The inter-frame dominant motion estimation module 102 may comprise a robust estimator such as a robust M-estimator which uses a robust function such as a Tukey function, Huber function, a Cauchy function, an absolute value function, or other suitable robust function. Using a robust estimator addresses the problem caused by the presence of objects which are subject to a different or independent motion than that of the camera. The independent motion of such objects may violate the main global motion assumption and can bias the estimate of the dominant motion.

The robust estimator may automatically detect outliers which correspond to pixels subject to a motion very different or independent from the dominant one. The robust estimator may ignore such outliers during the estimation procedure by down-weighting the corresponding equations. By using an estimation technique based on robust statistics, data points considered to be outliers (e.g., independently moving objects) are automatically discounted. Accordingly, estimates corresponding to the dominant trend or dominant motion are produced which best explains the changes between the two successive frames.

The trajectory computation module 104 may be arranged to determine an estimated trajectory. Once the relative motion between every two frames has been estimated, the trajectory computation module 104 may calculate an estimated trajectory of the camera with respect to the first frame as the composition of all the relative alignments. As an example, in the case of considering a pure translation model, this corresponds to the cumulative vectorial sum of all the displacements up to the current frame.

The trajectory smoothing module 106 may be arranged to determine a smoothed trajectory. The trajectory smoothing module 106 may calculate a smoothed version of the trajectory, for example, by filtering both the displacement in horizontal and vertical dimensions with a low pass filter (e.g., low pass Gaussian filter) of a given standard deviation.

The jitter compensation module 108 may be arranged to perform motion compensation to compensate for estimated jitter and to generate a stabilized image sequence 112. In various embodiments, the estimated jitter may be calculated by subtracting the smoothed version of the trajectory from the estimated trajectory. The objective of image stabilization is to compensate for unwanted camera jitter, but not for genuine camera motion such as panning, true camera displacement, etc. High-frequency variations in the trajectory may be associated with or correspond to unwanted camera jitter, and low-frequency or smooth variations in the trajectory may be associated with or correspond to wanted camera motions.

For the pure displacement model, the displacements can be approximated as integers. The motion compensation, therefore, may involve selecting the appropriate sub-region of the image with the origin given by the displacement corresponding to the jitter. In the case of the rotation plus translation model, it is necessary to compensate for this rigid transformation which may require interpolating pixel values on a rotated pixel grid using an appropriate interpolation technique such as bi-linear or bi-cubic interpolation.

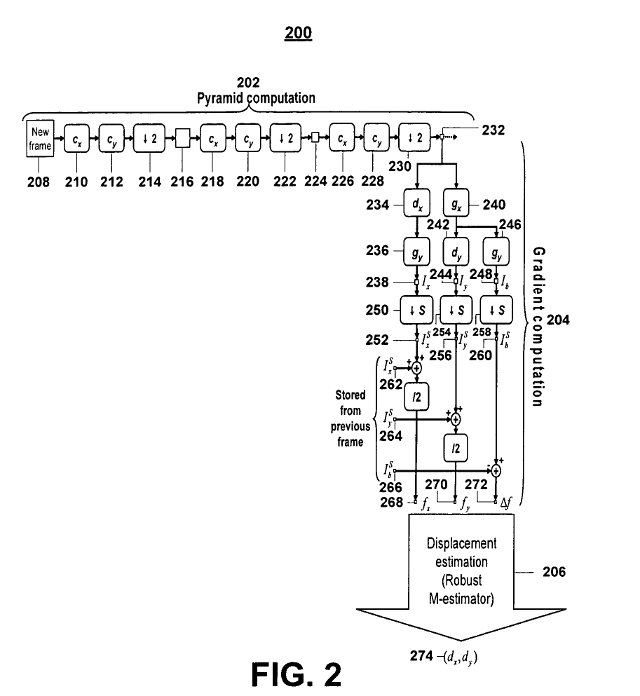

FIG. 2 illustrates an inter-frame dominant motion estimation module 200 in accordance with one or more embodiments. Although not limited in this context, the inter-frame dominant motion estimation module 200 may be implemented by the media processing system 100 of FIG. 1. In various implementations, the inter-frame dominant motion estimation module 200 may be arranged to perform dominant motion estimation to support image stabilization by estimating the motion model parameters that best align a current image with a previous neighboring image.

As shown, the inter-frame dominant motion estimation module 200 may comprise a pyramid computation portion 202, a gradient computation portion 204, and a displacement estimation portion 206, which may be implemented as hardware, software, or any combination thereof, as desired for a given set of design parameters or performance constraints.

The pyramid computation portion 202 may be arranged to obtain a multi-resolution pyramid of an image or frame at a desired resolution level. In various embodiments, the pyramid computation portion 202 may perform cascaded operations comprising successive filtering and down-sampling in the horizontal and vertical dimensions until the desired resolution level is reached. It can be appreciated that the number of pyramid levels can be adjusted based on the size of the original image, the desired accuracy, available computational power, and so forth. Although the embodiments are not limited in this context, the filtering and down-sampling generally may be performed iteratively to reduce computational expense.

As shown in FIG. 2, the pyramid computation block 202 may filter a new frame 208 with a horizontal low pass filter (cₓ) 210 and a vertical low pass filter (c_{y}) 212 and then perform down-sampling by a decimating factor (S) 214 resulting in a reduced image 216. Further filtering and down-sampling may be performed with a horizontal low pass filter (cₓ) 218, a vertical low pass filter (c_{y}) 220, and a decimating factor (S) 222 resulting in a further reduced image 224. Filtering and down-sampling may be performed again with a horizontal low pass filter (cₓ) 226, a vertical low pass filter (c_{y}) 228, and a decimating factor (S) 230 resulting in a still further reduced image 232. In one embodiment, the low pass filters may be implemented as Gaussian filters such as cubic B-Spline filters with convolution mask c=(0.0625 0.25 0.375 0.25 0.0625), and a decimating factor S=2 may be used in both dimensions. The embodiments, however, are not limited in this context.

The gradient computation portion 204 may be arranged to align a current image with a previous neighboring image by estimating global motion model parameters using the optical flow gradient constraint. In various embodiments, the gradient computation portion 204 may obtain the spatio-temporal gradient between the current image and a previous neighboring image comprising the spatial gradient in the horizontal (x) and vertical (y) dimensions and the temporal gradient in time (t).

The spatial gradient may be obtained by filtering or convolving both images with appropriate Gaussian derivative kernels and then taking the average of both results. The temporal gradient may be obtained by filtering or convolving both images with appropriate Gaussian kernels and then taking the difference between both results.

As shown in FIG. 2, the reduced image 232 may be received within the gradient computation portion 204 and filtered by a horizontal Gausian derivative filter (dₓ) 234 and a vertical low pass filter (g_{y}) 236 resulting in an image (Iₓ) 238. The image 232 also may be filtered by a horizontal low pass filter (gₓ) 240. The image filtered by the horizontal low pass filter (gₓ) 240 may be filtered by a vertical Gaussian derivative filter (d_{y}) 242 resulting in an image (I_{y}) 244. The image filtered by the horizontal low pass filter (gₓ) 240 also may be filtered by a vertical low pass filter (g_{y}) 246 resulting in an image (I_{b}) 248. In one embodiment, the low pass filters may be implemented with convolution mask g=(0.03505 0.24878 0.43234 0.24878 0.03504), and convolution mask d=(0.10689 0.28461 0.0 −0.28461 −0.10689). The embodiments, however, are not limited in this context.

To reduce computations and storage, the image (Iₓ) 238 may be down-sampled by a decimating factor (S) 250 resulting in an image (Iₓ^{S}) 252, the image (I_{y}) 244 may be down-sampled by a decimating factor (S) 254 resulting in an image (I_{y}^{S}) 256, and the image (I_{b}) 248 may be down-sampled by a decimating factor (S) 258 resulting in an image (I_{b}^{S}) 260. In one embodiment, a decimating factor S=2 may be used in both dimensions. The embodiments, however, are not limited in this context.

Within the gradient computation portion 204, the image (Iₓ^{S}) 252, the image (I_{y}^{S}) 256, and the image (I_{b}^{S}) 260 for the current frame may be stored and then properly combined to an image (Iₓ^{S}) 262, an image (I_{y}^{S}) 264, and an image (I_{b}^{S}) 266 stored from the previous frame to obtain the spatio-temporal gradient between the current image and a previous neighboring image. In various embodiments, the spatio-temporal gradient may comprise the horizontal spatial gradient (fₓ) 268, the vertical spatial gradient (f_{y}) 270, and the temporal gradient (Δf) 272.

The spatio-temporal gradient between the two frames may be obtained, where (fₓⁱ, f_{y}ⁱ, fₜⁱ) is the spatio-temporal gradient of the two frames at pixel i. Assuming a pure displacement model, the displacement is constrained by the equation at pixel i: fₓⁱdₓ+f_{y}ⁱd_{y}+fₜⁱ=0, where (fₓⁱ, f_{y}ⁱ, fₜⁱ) is the spatio-temporal gradient of the two frames at pixel i, and d=(dₓ,d_{y})^{T} is the unknown displacement corresponding to the dominant motion in the horizontal and vertical dimensions.

The displacement estimation portion 206 may be arranged to determine the unknown displacement in the horizontal and vertical dimensions (dₓ,d_{y}) 274 corresponding to the dominant motion. By gathering together the constraints corresponding to the pixels in the current image, an over-determined linear system may be formed which relates the spatio-temporal gradient with the unknown displacement of the form Fₛd=Fₜ, where the matrix Fₛ contains the spatial gradients, and the column vector Fₜ contains the temporal gradients. It can be appreciated that all the pixels in the current image may be used or that a subset of the pixels may be used to reduce computations.

In various embodiments, the displacement estimation portion 206 may comprise a robust estimator such as a robust M-estimator to solve the over-determined linear system. In such embodiments, the M-estimator may use a robust function such as a Tukey function, Huber function, a Cauchy function, an absolute value function, or other suitable robust function instead of a square function used in least-squares. Using a robust estimator addresses the problem caused by the presence of objects which are subject to a different or independent motion than that of the camera. The independent motion of such objects may violate the main global motion assumption and can bias the estimate of the dominant motion.

The robust estimator may automatically detect outliers which correspond to pixels subject to a motion very different or independent from the dominant one. The robust estimator may ignore such outliers during the estimation procedure by down-weighting the corresponding equations. By using an estimation technique based on robust statistics, data points considered to be outliers (e.g., independently moving objects) are automatically discounted. Accordingly, estimates corresponding to the dominant trend or dominant motion are produced which best explains the changes between the two successive frames.

In various embodiments, the dominant motion estimate may be iteratively refined by warping one of the images according to the current estimate and repeating the estimation procedure. Once the maximum number of iterations is reached or the change in the estimate is below a given threshold, the estimation procedure stops at the current pyramid level and the estimate is used as an initial estimate for the previous pyramid level.

The displacement in the horizontal and vertical dimensions (dₓ,d_{y}) 274 corresponding to the dominant motion may be a global displacement based on the assumption that the camera motion is a translation contained in the imaging plane. In some cases, however, the dominant motion can be a global displacement plus a rotation between the two images which corresponds to the assumption that the camera motion is a translation contained in the imaging plane plus a rotation around an axis orthogonal to the image plane. In such cases, the two neighboring images may be approximately displaced and potentially rotated versions of each other.

In the case of considering the rotation plus translation model, the parameters to be estimated may comprise the displacement plus the rotation angle, and the procedure to estimate them is similar. In various implementations, the procedure may involve the multiplication of the two matrices corresponding to the rotation plus translation, such as the matrix from frame 1 to frame 2 multiplied by the matrix from frame 2 to frame 3. In one embodiment, each rotation plus translation matrix may comprise a 3×3 matrix in which the first 2×2 block of the matrix is the rotation matrix, the first two elements of the last column are the displacement dₓ and d_{y}, and the bottom row is [0 0 1]. The embodiments, however, are not limited in this context.

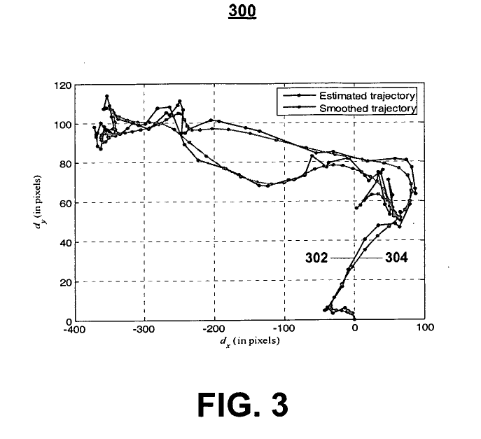

FIG. 3 illustrates estimated and smoothed trajectories for a typical image sequence in accordance with one or more embodiments. As shown, the graph 300 includes a blue line 302 representing the estimated trajectory, and a red line 304 representing the smoothed trajectories for a typical image sequence. The values are in pixels. It can be appreciated that this example is provided for purposes of illustration, and the embodiments are not limited in this context.

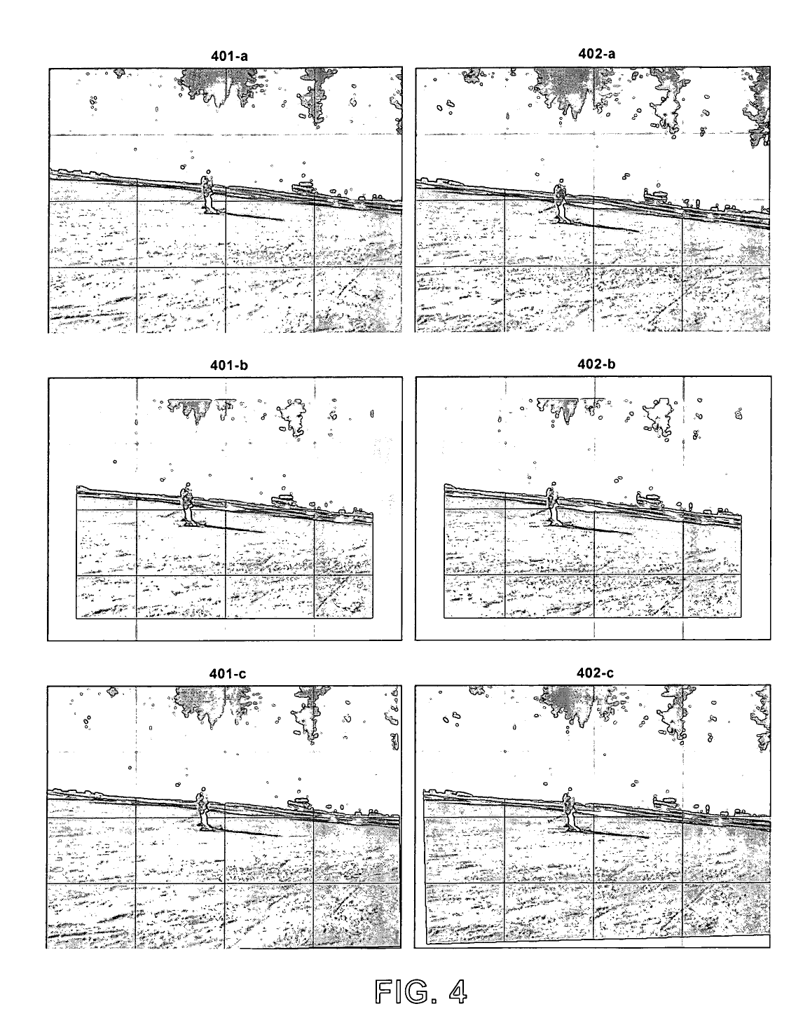

FIG. 4 illustrates one embodiment of a typical stabilization results for two neighboring frames in a test sequence. A red grid has been super-imposed on all the images to facilitate the visual comparison of the stabilization. In the top row, a large jitter due to unwanted camera motion is shown between original consecutive frames 401-a and 402-a of the sequence. In the middle row, unwanted jitter has been compensated for between consecutive frames 401-b and 402-b after stabilization using the pure translational alignment model. In the bottom row, unwanted jitter has been compensated for between consecutive frames 401-c and 402-c after stabilization using the rotation plus translation alignment model. It can be appreciated that this example is provided for purposes of illustration, and the embodiments are not limited in this context.

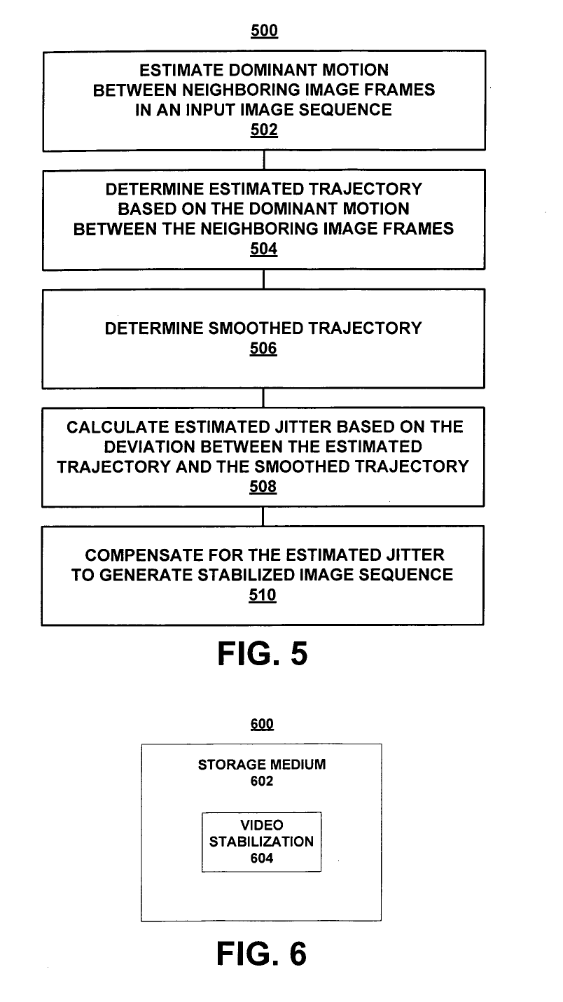

FIG. 5 illustrates a logic flow 500 in accordance with one or more embodiments. The logic flow 500 may be performed by various systems and/or devices and may be implemented as hardware, software, and/or any combination thereof, as desired for a given set of design parameters or performance constraints. For example, the logic flow 500 may be implemented by a logic device (e.g., processor) and/or logic (e.g., threading logic) comprising instructions, data, and/or code to be executed by a logic device.

The logic flow 500 may comprise estimating dominant motion between neighboring image frames in the input image sequence (block 502). The displacement (e.g., dₓ and d_{y}) corresponding to the dominant motion may be a global displacement and/or a global displacement plus a rotation between the two images. Dominant motion estimation may be performed by a robust estimator such as a robust M-estimator which uses a robust function (e.g., Tukey function, Huber function, Cauchy function, absolute value function, etc.) The robust estimator may automatically detect and ignore outliers which correspond to pixels subject to a motion very different or independent from the dominant one.

The logic flow 500 may comprise determining an estimated trajectory based on the dominant motion between the neighboring image frames (block 504). The estimated trajectory of a camera may be determined with respect to the first frame as the composition of all the relative alignments. In the case of a pure translation model, for example, the estimated trajectory may correspond to the cumulative sum of all the displacements up to the current frame.

The logic flow 500 may comprise determining a smoothed trajectory (block 506). A smoothed version of the trajectory may be computed by filtering both the horizontal and vertical displacement with a low pass filter (e.g., low pass Gaussian filter) of a given standard deviation.

The logic flow 500 may comprise calculating estimated jitter based on the deviation between the estimated trajectory and the smoothed trajectory (block 508). The estimated jitter may be calculated by subtracting the smoothed version of the trajectory from the estimated trajectory. High-frequency variations in the trajectory may be associated with or correspond to unwanted camera jitter, and low-frequency or smooth variations in the trajectory may be associated with or correspond to wanted camera motions.

The logic flow 500 may comprise compensating for the estimated jitter to generate a stabilized image sequence (block 510). For the pure displacement model, the displacements can be approximated as integers. The motion compensation, therefore, may involve selecting the appropriate sub-region of the image with the origin given by the displacement. In the case of the rotation plus translation model, compensation may involve interpolating pixel values on a rotated pixel grid using an appropriate interpolation technique such as bi-linear or bi-cubic interpolation.

FIG. 6 illustrates one embodiment of an article of manufacture 600. As shown, the article 600 may comprise a storage medium 602 to store video stabilization logic 504 for performing various operations in accordance with the described embodiments. In various embodiments, the article 600 may be implemented by various systems, components, and/or modules.

The article 600 and/or computer-readable storage medium 602 may include one or more types of storage media capable of storing data, including volatile memory or, non-volatile memory, removable or non-removable memory, erasable or non-erasable memory, writeable or re-writeable memory, and so forth. Examples of a computer-readable storage medium may include, without limitation, RAM, DRAM, Double-Data-Rate DRAM (DDRAM), synchronous DRAM (SDRAM), static RAM (SRAM), ROM, programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other type of computer-readable storage media suitable for storing information.

The article 600 and/or computer-readable medium 602 may store video stabilization logic 604 comprising instructions, data, and/or code that, if executed by a system, may cause the system to perform a method and/or operations in accordance with the described embodiments. Such a system may include, for example, any suitable processing platform, computing platform, computing device, processing device, computing system, processing system, computer, processor, or the like, and may be implemented using any suitable combination of hardware and/or software.

The video stabilization logic 604 may comprise, or be implemented as, software, a software module, an application, a program, a subroutine, instructions, an instruction set, computing code, words, values, symbols or combination thereof. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may comprise one or more elements. An element may comprise any structure arranged to perform certain operations. Each element may be implemented as hardware, software, or any combination thereof, as desired for a given set of design and/or performance constraints. Although an embodiment may be described with a limited number of elements in a certain topology by way of example, the embodiment may include more or less elements in alternate topologies as desired for a given implementation.

It is worthy to note that any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. With respect to software elements, for example, the term “coupled” may refer to interfaces, message interfaces, API, exchanging messages, and so forth.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. An apparatus, comprising:
an inter-frame dominant motion estimation module to receive an input image sequence and to estimate dominant motion between neighboring images in the image sequence, the inter-frame dominant motion estimation module comprising a robust estimator to automatically detect and discount outliers corresponding to independently moving objects.

2. The apparatus of claim 1, wherein the dominant motion comprises at least one of a global displacement and a global displacement plus a rotation between the neighboring images.

3. The apparatus of claim 1, wherein the robust estimator uses a robust function.

4. The apparatus of claim 3, the robust function comprising at least one of a Tukey function, a Huber function, a Cauchy function, and an absolute value function.

5. The apparatus of claim 1, further comprising a trajectory computation module to determine estimated trajectory based on the dominant motion.

6. The apparatus of claim 5, further comprising a trajectory smoothing module to determine a smoothed trajectory.

7. The apparatus of claim 6, further comprising a jitter compensation module to compensate for estimated jitter, the estimated jitter based on deviation between the estimated trajectory and the smoothed trajectory.

8. The apparatus of claim 1, wherein the apparatus comprises an image acquisition device.

9. A system, comprising:
an apparatus coupled to an antenna, the apparatus comprising an inter-frame dominant motion estimation module to receive an input image sequence and to estimate dominant motion between neighboring images in the image sequence, the inter-frame dominant motion estimation module comprising a robust estimator to automatically detect and discount outliers corresponding to independently moving objects.

10. The system of claim 9, wherein the dominant motion comprises at least one of a global displacement and a global displacement plus a rotation between the neighboring images.

11. The system of claim 9, wherein the robust estimator uses a robust function.

12. The system of claim 11, the robust function comprising at least one of a Tukey function, a Huber function, a Cauchy function, and an absolute value function.

13. The system of claim 9, further comprising a trajectory computation module to determine estimated trajectory based on the dominant motion.

14. The system of claim 13, further comprising a trajectory smoothing module to determine a smoothed trajectory.

15. The system of claim 14, further comprising a jitter compensation module to compensate for estimated jitter, the estimated jitter based on deviation between the estimated trajectory and the smoothed trajectory.

16. A method, comprising:
estimating dominant motion between neighboring images in an image sequence using a robust estimator to automatically detect and discount outliers corresponding to independently moving objects.

17. The method of claim 16, wherein the dominant motion comprises at least one of a global displacement and a global displacement plus a rotation between the neighboring images.

18. The method of claim 16, wherein the robust estimator uses a robust function.

19. The method of claim 18, the robust function comprising at least one of a Tukey function, a Huber function, a Cauchy function, and an absolute value function.

20. The method of claim 16, further comprising determining an estimated trajectory based on the dominant motion.

21. The method of claim 20, further comprising determining a smoothed trajectory.

22. The method of claim 21, further comprising compensate for estimated jitter, the estimated jitter based on deviation between the estimated trajectory and the smoothed trajectory.

23. An article comprising a computer-readable storage medium containing instructions that if executed enable a system to:
estimate dominant motion between neighboring images in an image sequence using a robust estimator to automatically detect and discount outliers corresponding to independently moving objects.

24. The article of claim 23, wherein the dominant motion comprises at least one of a global displacement and a global displacement plus a rotation between the neighboring images.

25. The article of claim 23, wherein the robust estimator uses a robust function.

26. The article of claim 25, the robust function comprising at least one of a Tukey function, a Huber function, a Cauchy function, and an absolute value function.

27. The article of claim 23, further comprising instructions that if executed enable the system to determine an estimated trajectory based on the dominant motion.

28. The article of claim 27, further comprising instructions that if executed enable the system to determine a smoothed trajectory.

29. The article of claim 28, further comprising instructions that if executed enable the system to compensate for estimated jitter, the estimated jitter based on deviation between the estimated trajectory and the smoothed trajectory.
